(19) United States
(12) Patent Application Publication
(10) Pub. No.: US 2014/0069314 A1
(43) Pub. Date: Mar. 13, 2014

(54) Underwater Signaling Device

(71) Applicant: Maxwell Everett Frey, Englewood, CO (US)

(72) Inventor: Maxwell Everett Frey, Englewood, CO (US)

(21) Appl. No.: 13/612,220

(22) Filed: Sep. 12, 2012

(51) Int. Cl. G10K 9/04; H04B 13/02; G08B 7/00

(52) U.S. Cl. 116/3; 116/142 FP; 340/850

(57) ABSTRACT

An underwater signaling device which has an independent source of pressurized gas can operate regardless of the status of a scuba diver's air source. The underwater signaling device produces a sound signal which may be heard beyond 100 feet, and the present disclosure may operate to depths of up to 250 feet. Further, the present disclosure may be supplemented by light strobe and/or GPS devices, which allow another diver to precisely locate a distressed diver. A diver may activate the present disclosure by depressing a button or by pulling a rip cord or other methods. In one embodiment, the present disclosure allows replacement of the independent source of pressurized gas, making the present disclosure reusable.

### FIELD OF THE INVENTION

The present disclosure relates to the field of diving equipment and devices which may be used as a signaling device.

### BACKGROUND OF THE INVENTION

Scuba (Self-Contained, Underwater Breathing Apparatus) diving is very popular, and the number of scuba divers is ever-increasing in a wide variety of fields: military, commercial, and recreational. A scuba system allows a diver to reach significant depths and remain underwater for extended periods of time, offering a major advantage over breath-holding divers. While a scuba diver's ability to reach lower depths for extended periods of time is an advantage, it also engenders a host of challenges. For example, a scuba diver may encounter obstacles in a body of water or on the floor of a body of water that he or she would not have encountered in a breath-holding dive. Further, most scuba gear does not allow a diver to communicate with another diver using his or her voice. In addition, illumination from both natural light and artificial light is obscured as a diver descends deeper in the water. As a result, a member of a group of divers may easily become lost and separated from the group.

The diving industry has attempted to provide some basic solutions to some of these challenges. Some scuba divers may customarily carry a knife which could free a diver if he or she is caught in an obstacle. However, not all scuba divers carry a knife, and some obstacles may be too tough for a scuba diver to cut through. Likewise, scuba divers may communicate with each other using hand signals to overcome the lack of voice communication. However, scuba divers may not always be able to see each other due to poor visibility or not being in the same line of sight.

Beyond knives and hand signals, the diving industry has attempted to develop more sophisticated signaling devices. For example, a device known as the Scuba-Alert uses sound waves to signal other divers. The Scuba-Alert uses small pulses of compressed air to vibrate a steel disk and generate a “quacking” sound. However, devices like the Scuba-Alert rely on the inflator hose of a scuba system and draw air from the scuba diver's primary source of air in order to operate. This is but one deficiency with the Scuba-Alert and other products like it, which create further hazard because a diver may be in the most peril when his or her air supply is dangerously low.

Another signaling device is known as the Buddy Call. The Buddy Call is battery powered and uses electronics to generate a signal to other divers. However, the Buddy Call's performance is lacking in many respects. For example, since the Buddy Call is electronic, it has a signal range of only 100 feet and a working depth of up to 110 feet, yet scuba divers may reach depths beyond 110 feet and easily become stranded more than 100 feet from their partner or the nearest rescue source. Also, the Buddy Call is bulky and may not be conveniently located on a diver's suit or other equipment to be easily accessed in the event of an emergency. Finally, the Buddy Call also presents the hazard of not operating due to loss of battery power, which is often undetectable until the device is needed.

### SUMMARY OF THE INVENTION

Therefore, it would be advantageous to have a more sophisticated signaling device which is independent of a scuba system, has a signal range beyond 100 feet, and a working depth of up to 250 feet. Other advantages over the prior art will become known upon review of the Summary of the Invention and Detailed Description and the appended claims.

In one embodiment of the present disclosure, an underwater signaling device uses its own independent source of pressurized gas to generate sound waves and gain the attention of other divers. The device may have a metal container for a body, and within the container a vessel may store pressurized gas as an independent source of pressurized gas. Because the pressurized gas is stored in a discrete vessel, the underwater signaling device does not tap into the regulator hose of a scuba system and draw air from a scuba diver's primary source of air. Therefore, unlike prior gas-operated signaling devices, the present disclosure operates regardless of the status of the scuba diver's regular air supply.

Further, the present disclosure generates sound waves which can be heard beyond 100 feet, and the present disclosure may operate to a working depth of up to 250 feet. In one embodiment, a puncture pin is located above the pressurized vessel, and a diver may activate a trigger mechanism to puncture the pressurized vessel, releasing the pressurized gas. In one embodiment of the present disclosure, a diver may activate the trigger mechanism by depressing a button located on top of the container such that the diver's own energy is pushing the puncture pin into the vessel. Once the vessel has been punctured, the pressurized gas flows upward and out of a tube which may extend laterally from the body of the container. Within this tube is a sounding device, such as a metal disk, which generates sound waves. The metal disk vibrates when the pressured vessel is punctured and generates sound waves as air moves past it. Beyond the tube, a frusto-conical element may be provided to amplify the sound waves so they may be heard by another diver who is over 100 feet away.

An embodiment of the present disclosure which uses metal materials may operate at increased depths. The container, vessel, and trigger mechanism may be constructed from a variety of metals. Therefore, the present disclosure could be operable to depths of up to 250 feet. This is a marked improvement in performance over electronic signal devices like the Buddy Call, which can only operate to a depth of up to 110 feet.

In a further embodiment, a light strobe or LED or other illumination source may be attached to the exterior of the container of the underwater signaling device. The same trigger mechanism which releases the pressurized gas from the vessel may also activate a light strobe to generate a light signal which complements the sound signal by way of a limit switch, presence sensor or other known input device. The light strobe may be useful in unexpected situations when the sound signal alone is insufficient to direct a second diver to the location of a distressed diver. For example, a second diver may not be able to easily locate a distressed diver if they are not in the same line of sight or there is poor visibility or if the sound signal is bouncing off rocks or coral in the vicinity of the diver, thereby creating an echo effect. The sound signal may alert the second diver and provide the second diver with a general direction where he or she may find the distressed diver. As the second diver travels toward the sound signal, the light strobe may help the second diver by providing a more precise location of the distressed diver.

In a similar vein, a GPS device may be used alone or with any embodiments of the present disclosure described herein, to provide an additional signal for other divers or a dive master or emergency personnel to find a distressed diver. The GPS device may provide a beacon which may be received by a divemaster located on a boat or land, as well as any other receiver which may received a GPS beacon such as a smart phone device. The receiver of such a signal may deploy a boat over the GPS beacon and deploy a diver.

In another embodiment of the disclosure, a diver may pull a rip cord to activate the trigger mechanism. In this embodiment, the trigger mechanism and puncture pin do not derive the energy to puncture the pressurized vessel from the user. Instead, a coiled spring rests behind the puncture pin. When a diver pulls the rip cord, the coiled spring is allowed to release, driving the puncture pin into the pressurized vessel and releasing the contents of the vessel.

Generally, the present disclosure may be attached to a diver in a variety of fashions. In one embodiment, an eyelet may be interconnected to the exterior wall of the container. A half-ring or any other connection component may be partially interconnected to the eyelet such that the ring or component may rotate freely. This eyelet-ring combination allows a diver to attach the present disclosure anywhere on a diver's buoyancy compensator.

Beyond eyelets, the present disclosure may be attached to a diver by other techniques, e.g. straps. A diver's gear may already provide straps such as the waist strap of the buoyancy compensator. Or the present disclosure may include straps which are independent of a diver's existing gear.

A person who is skilled in the art may appreciate techniques to attach the present disclosure to a diver beyond eyelets and straps. For example, the present disclosure may be integrated into a diver's suit. The present disclosure could be woven into a waist pouch.

In another embodiment of the present disclosure, the signaling device may interface with a device on a diver's arm such as a wrist clip, diving computer, amulet, diving watch, or any other component which may activate or send a communiqué to the present disclosure. In this embodiment, a diver may activate the signaling device using the same hand that has an additional device attached. Therefore, if a diver has one arm which is entangled or otherwise encumbered, then the diver may activate the present disclosure using his or her free arm which has a wrist clip, diving computer, amulet, diving watch, or any other component which may activate or send a communiqué to the present disclosure.

The Summary of the Invention is neither intended nor should it be construed as being representative of the full extent and scope of the present disclosure. The present disclosure is set forth in various levels of detail in the Summary of the Invention as well as in the attached drawings and the Detailed Description of the Invention and no limitation as to the scope of the present disclosure is intended by either the inclusion or non-inclusion of elements, components, etc. in this Summary of the Invention. Additional aspects of the present disclosure will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present disclosure are possible utilizing, alone or in combination, as set forth above and/or described in the accompanying figures and/or in the description herein below.

### BRIEF DESCRIPTION OF THE DRAWINGS

The accompanying drawings, which are incorporated in and constitute a part of the specification, illustrate embodiments of the disclosure and together with the general description of the disclosure given above and the detailed description of the drawings given below, serve to explain the principles of the disclosures.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

In the drawings:

FIG. 1 shows a side view of one embodiment of the present disclosure where the trigger mechanism is a depressible button.

FIG. 2 shows a side view of one embodiment of the present disclosure where the trigger mechanism is a rip cord selectively interconnected to a spring-loaded vertical component.

FIG. 3 is an isometric view of one embodiment of the present disclosure.

FIG. 4 is a side view of one embodiment of the present disclosure which demonstrates the generation of sound waves.

### DETAILED DESCRIPTION

The subject of the present disclosure relates to an underwater signaling device which has advantages over gas-operated devices and electronic devices. In one embodiment of the present disclosure, the component materials are made of metal, which allows for greater resistance to water pressure as the depth of operation increases. However, a person who is skilled in the art may identify another material, or materials, which is advantageous for operation depth or other parameters.

As described in detail below, various embodiments of the present disclosure comprise a novel valve, further comprising an inlet connection and an outlet connection, each connection further comprising a horizontal and vertical adjustment means, and/or other features.

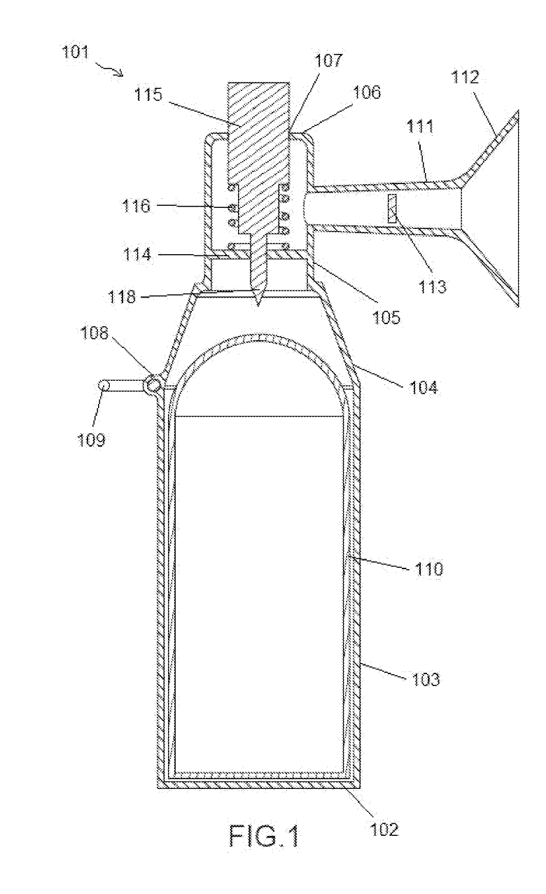

FIG. 1 is a side view of one embodiment of the present disclosure. The bottom side of the underwater signaling device 101 may begin with a substantially planar bottom wall 102. A person who is skilled in the art may determine that it would be advantageous to have the bottom wall 102 be detachable in order to create a reusable underwater signaling device 101.

The bottom wall 102 interconnects or selectively interconnects with at least one upwardly-extending lower wall 103. Within a portion of this wall 103 is a vessel 110 which contains pressurized gas. This vessel 110 is advantageous because the source of air for the underwater signaling device 101 is independent of the diver's air supply. Further, the vessel 110 may be configured or designed to be punctured, releasing the pressurized gas.

Continuing upward, one particular embodiment of the present disclosure has an upwardly-extending, frusto-conical wall 104 interconnected to the at least one upwardly-extending lower wall 110. The frusto-conical wall 104 tapers to a smaller diameter. At least one upwardly-extending upper wall 105 is interconnected with the frusto-conical wall 104. Finally, a substantially planar top wall 106 is interconnected with the at least one upwardly-extending upper wall 105.

The aforementioned elements of this particular embodiment of the present disclosure form a basic container of the underwater signaling device 101 which contains a vessel 110 for holding and selectively releasing a pressurized gas.

Various embodiments of the present disclosure may puncture the vessel 110 in order to release its pressurized gas. The trigger mechanism 115 with a puncture pin 118 is substantially positioned inside of the container and above the vessel 110. A portion of the trigger mechanism 115 extends upward through an opening 107 in the top wall 106 such that a user may depress this extended portion to activate the trigger mechanism 115. A guide plate 114 may keep the trigger mechanism substantially vertical, and the guide plate 114 provides a surface for the spring 116 to compress against. The spring 116 presents an upward force against the trigger mechanism 115 to keep the puncture pin 118 away from the vessel 110 before the trigger mechanism 115 is activated. When a user depresses the trigger mechanism 115, the puncture pin 118 punctures the vessel 110 and releases the pressurized gas.

A laterally extending tube 111 is interconnected to at least one upwardly-extending upper wall 105 such that the tube 111 communicates with the interior of the underwater signaling device 101. Within the tube 111 is a metal disk 113 or similar device which vibrates as pressurized gas rushes over it. When the pressurized gas is released from the vessel 110, it rushes out of the laterally extending tube 111. The vibrating metal disk 113 generates sound waves which travel out of the laterally extending tube 111. A second, frusto-conical wall 112 may be interconnected to the laterally extending tube 111. This frusto-conical wall 112 may amplify the sound waves generated by the vibrating metal disk 113.

Various embodiments of the present disclosure may attach to a user's body or gear. An eyelet may be interconnected to the at least one upwardly-extending lower wall 103. In this particular embodiment, a half ring 109 is partially interconnected with the eyelet 108 such that the half-ring may freely rotate. This half ring 109 may attach to the user or diver via a carabiner on the diver's gear.

In a further embodiment, a person who is skilled in the art may appreciate additional components to the underwater signaling device 101 which enhance or complement the devices' audible signal. For example, an embodiment of the present disclosure may have a light strobe which is interconnected to the at least one upwardly-extending lower wall 103. A light strobe may be an advantageous complement to the audible signal since a second diver may not be able to immediately locate the distressed diver with the audible signal. A light strobe component would help a second diver precisely locate a distressed diver.

In yet another embodiment of the present disclosure, a GPS device may be used alone, or with any embodiments of the present disclosure provided herein, to provide an additional signal for other divers to find a distressed diver. The GPS device may be interconnected to the first upwardly-extending wall 103 of the underwater signaling device 101. The GPS device may provide a beacon which may be received by a divemaster located on a boat or land, as well as any other receiver which may received a GPS beacon such as a smart phone device. The receiver of such a signal may deploy a boat over the GPS beacon and deploy a diver.

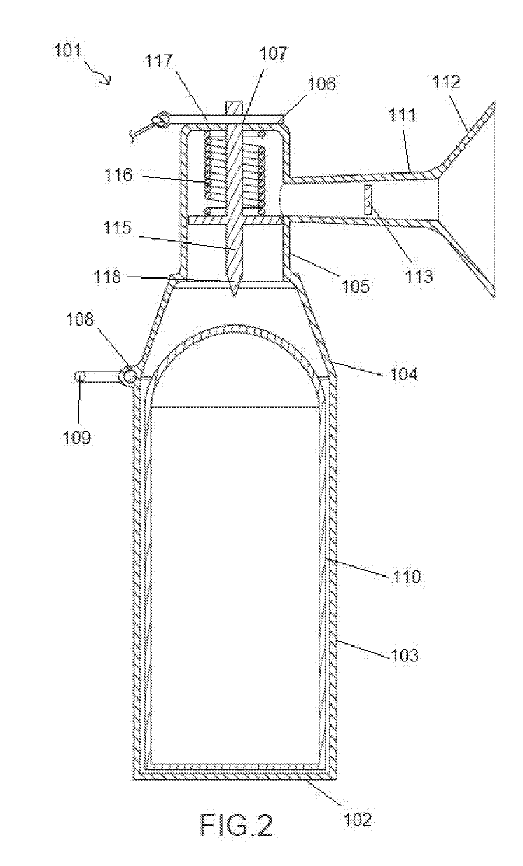

FIG. 2 shows a side view of a further embodiment of the present disclosure. Here, a user activates the trigger mechanism 115 by pulling a rip cord 117, not depressing a button. The trigger mechanism 115 has a portion extending through the opening 107 in the top wall 106. A rip cord 117 secures this extended portion of the trigger mechanism 115 in place. In this static position a spring 116 is coiled inside of the underwater signaling device 101 between the top wall 106 and a lateral portion of the trigger mechanism 115. When a user pulls the rip cord 117, the spring 116 is allowed to drive the trigger mechanism 115 and its puncture pin 118 into the vessel 110, releasing pressurized gas.

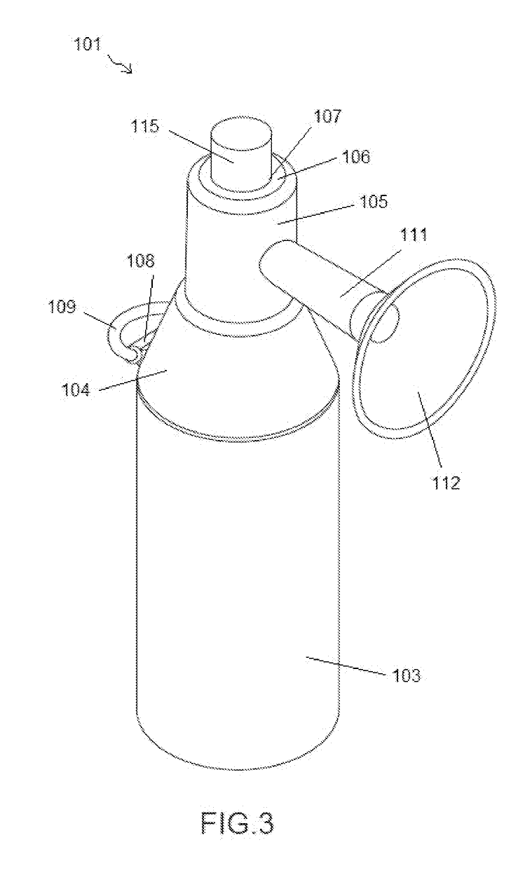

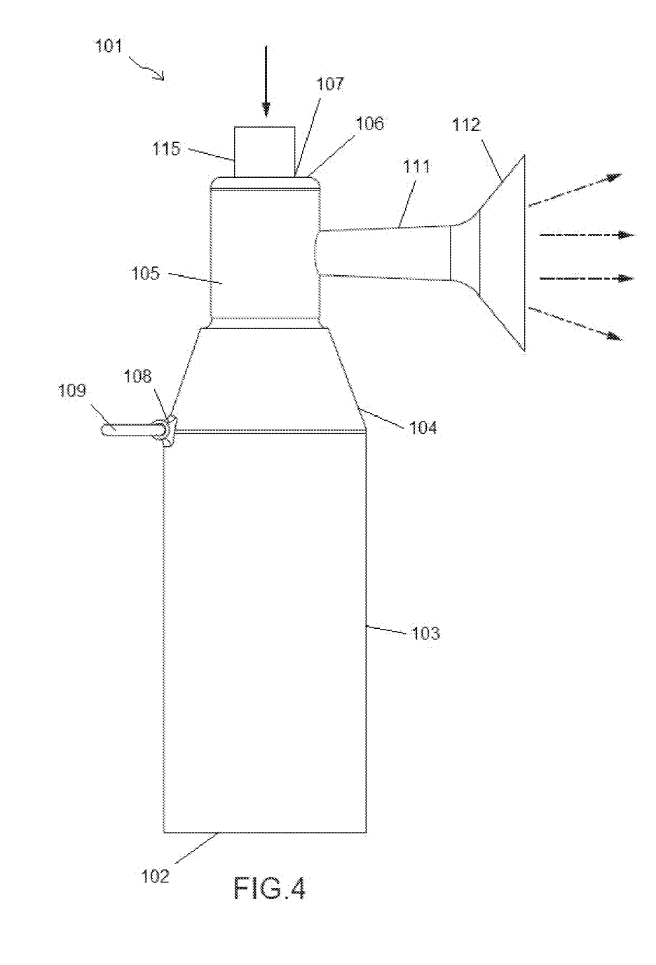

FIG. 3 shows an isometric view of one embodiment of the present disclosure. In this embodiment the trigger mechanism 115 is a depressible button. FIG. 4 shows a side view of one embodiment of the present disclosure where the trigger mechanism 115 is a depressible button. This figure demonstrates how the present disclosure projects sound waves.

The foregoing description of the present disclosure has been presented for illustration and description purposes. However, the description is not intended to limit the invention to only the forms disclosed herein. In the foregoing Detailed Description for example, various features are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Consequently, variations and modifications commensurate with the above teachings and skill and knowledge of the relevant art are within the scope of the present invention. The embodiments described herein above are further intended to explain best modes of practicing the invention and to enable others skilled in the art to utilize the invention in such a manner, or include other embodiments with various modifications as required by the particular application(s) or use(s) of the present invention. Thus, it is intended that the claims be construed to include alternative embodiments to the extent permitted by the prior art.

What is claimed is:

1. An underwater signaling device, comprising:
a container;
a vessel located within the container where the vessel holds at least one of a pressurized gas, a pressurized fluid and a pressurized liquid;
a trigger mechanism located at least partially within the container;
an opening in the container which allows a user to activate the trigger mechanism, causing the vessel to release the pressurized gas;
a laterally extending tube interconnected to the container such that the released pressurized gas is communicated to the surrounding environment; and
a metal disk located in the laterally extending tube, wherein the metal disk vibrates as the released pressurized gas rushes over it, and the metal disk generates sound waves.

2. The underwater signaling device of claim 1, further comprising a laterally extending, frusto-conical wall interconnected to the laterally extending tube, the frusto-conical wall tapering to a larger diameter as it extends away from the underwater signaling device.

3. The underwater signaling device of claim 1, wherein an eyelet is interconnected to the container.

4. The underwater signaling device of claim 3, wherein a half-ring is partially interconnected to the eyelet such that the half-ring may rotate within the eyelet and allow attachment of the underwater signaling device to a user's body.

5. The underwater signaling device of claim 1, wherein a substantially horizontally guide plate is interconnected to the interior of the container.

6. The underwater signaling device of claim 5, wherein the trigger mechanism further comprises a pin and a biasing member abuts against the guide plate and biases against the trigger mechanism such that the pin does not contact the vessel when the trigger mechanism is not activated.

7. The underwater signaling device of claim 6, wherein the trigger mechanism has a depressible button which extends through the opening in the container such that depression of the button drives the pin into and punctures the vessel.

8. The underwater signaling device of claim 7, wherein the trigger mechanism has a substantially horizontal plate such that the biasing member is positioned between the plate and an interior wall of the container.

9. The underwater signaling device of claim 8, wherein the trigger mechanism partially extends through the opening in the container, and a rip cord retains the trigger mechanism above the vessel such that the biasing member is in a biased state, wherein removing the rip cord from the underwater signaling device allows the biasing member to become released from a biased state and drive the trigger mechanism and the pin into the vessel.

10. The underwater signaling device of claim 1, wherein an illumination source, which emits a light signal, is interconnected to the exterior of the container and is in communication with the trigger mechanism.

11. The underwater signaling device of claim 10, wherein activation of the trigger mechanism prompts an electric signal to an illumination source, activating an illumination source.

12. The underwater signaling device of claim 1, wherein a GPS device, which emits a GPS signal, is interconnected to the exterior of the container and is in communication with the trigger mechanism.

13. The underwater signaling device of claim 12, wherein activation of the trigger mechanism prompts an electric signal to the GPS device, activating the GPS device.

14. An underwater signaling device, comprising:
a substantially planar base interconnected, or partially interconnected, to at least one upwardly-extending lower wall;
a upwardly-extending, frusto-conical wall interconnected to the a least one upwardly-extending lower wall;
at least one upwardly-extending upper wall interconnected to the upwardly-extending, frusto-conical wall;
a substantially planar top wall interconnected to the at least one upwardly-extending upper wall such that the base; at least one lower wall; frusto-conical wall; at least one side wall; and top wall form a container;
a vessel located within the container where the vessel holds pressurized gas;
a trigger mechanism with a puncture pin located substantially within the container, adjacent to the top wall;
an opening in the top wall of the container which allows a user to activate the trigger mechanism, causing the puncture pin to puncture the vessel and release the pressurized gas;
a laterally extending tube interconnected to the at least one upwardly-extending upper wall such that the released pressurized gas is communicated out of the underwater signaling device; and
a metal disk located in the laterally extending tube where the metal disk vibrates as the released pressurized gas rushes over it, and the metal disk generates sound waves.

15. The underwater signaling device of claim 14, wherein the upwardly-extending, frusto-conical wall tapers to a smaller diameter as it extends upward.

16. The underwater signaling device of claim 14, wherein the substantially planar base is partially interconnect to the at least one upwardly-extending lower wall such that the vessel may be replaced, and the underwater signaling device is reusable.

17. The underwater signaling device of claim 14, wherein a laterally extending, frusto-conical wall is interconnected to the laterally extending tube, and the frusto-conical wall tapers to a larger diameter as it extends away from the underwater signaling devices in order to amplify the sound waves exiting the laterally extending tube.

18. The underwater signaling device of claim 14, wherein an eyelet is interconnected to the exterior of the at least one upwardly-extending lower wall.

19. The underwater signaling device of claim 18, wherein a half-ring is partially interconnected to the eyelet such that the half-ring's straight side may freely rotate within the eyelet and allow attachment of the underwater signaling device to a user's body.

20. A method for emitting underwater signals, comprising the steps of:
placing a vessel which contains pressurized gas in a container where a laterally extending tube is interconnected to the container, and the tube contains a metal disk;
providing an opening in the container which allows a user to communicate with a trigger mechanism, which has a puncture pin and is located inside of the container, adjacent to the opening; and
activating the trigger mechanism, causing the puncture pin to puncture the vessel, releasing the gas which flows through the laterally extending tube and over the metal disk, causing the metal disk to vibrate and generate sound waves.
